(19) United States
(12) Patent Application Publication
(10) Pub. No.: US 2015/0280881 A1
(43) Pub. Date: Oct. 1, 2015

(54) CONTROL CHANNEL CONFIGURATION FOR STAND-ALONE NEW CARRIER TYPE

(71) Applicants: Chunyan GAO, Xicheng District, Beijing (CN); Erlin ZENG, Haidian District, Beijing (CN); Shuang TAN, Changping District, Beijing (CN); Na WEI, Chaoyang District, Beijing (CN); Wei HONG, Haidian District, Beijing (CN); Pengfei SUN, Tongzhou District, Beijing (CN); Wei BAI, Chaoyang District, Beijing (CN); Lili ZHANG, Haidian District, Beijing (CN)

(72) Inventors: Chunyan Gao, Beijing (CN); Erlin Zeng, Beijing (CN); Shuang Tan, Beijing (CN); Na Wei, Beijing (CN); Wei Hong, Beijing (CN); Pengfei Sun, Beijing (CN); Wei Bai, Beijing (CN); Lili Zhang, Beijing (CN)

(73) Assignee: Broadcom Corporation, Irvine, CA (US)

(21) Appl. No.: 14/434,326

(22) PCT Filed: Oct. 10, 2012
(86) PCT No.: PCT/CN2012/082688

§ 371 Date: Apr. 8, 2015

(51) Int. Cl. H04L 5/00; H04W 72/04

(52) U.S. Cl. CPC H04L 5/0053; H04W 72/042

(57) ABSTRACT

A user equipment UE determines at least one first set SI of physical resource blocks PRBs, and detects downlink signaling within search spaces of set(s) SI. Through that downlink signaling the UE obtains a configuration for a downlink control channel, and that configuration indicates at least one second set S2 of PRBs and at least one search space specific for the UE which lies within S2. The UE utilizes the obtained configuration to monitor at least some of the search spaces of SI and the at least one search space specific for the UE of S2 for further downlink control signaling. Multiple implementations are detailed for how the UE gets SI. This invention is particularly useful for a configurable ePDCCH region in a stand-alone carrier where the UE is not able to get the new configuration from some other carrier such as a PCell whose configuration does not change.

### TECHNICAL FIELD

The exemplary and non-limiting embodiments of this invention relate generally to wireless communication systems, methods, devices and computer programs, and more specifically relate to configuring a control channel in a standalone carrier such as for example an ePDCCH in a new carrier type proposed for LTE Release 11.

### BACKGROUND

The Third Generation partnership Project 3GPP is working towards a Long Term Evolution LTE-Advanced system which is to introduce enhancements to carrier aggregation in LTE-Release 11, sometimes termed LTE-Advanced or LTE-A. the bandwidth in LTE-A is to utilize carrier aggregation CA, which has proved successful in coping with the large amount of traffic often encountered in urban areas. In CA there is a primary component carrier (PCC, sometimes referred to as the primary cell or PCell) for each user equipment (UE) and some UEs that are compatible with CA may also be configured for one or more secondary component carriers (SCCs, sometimes referred to as secondary cells or SCells).

The network may operate the SCCs via remote radio heads RRHs or pico cells in some deployments for hotspot coverage. In practice adjacent hotspots within the coverage area of a single macro-cell PCC will use different frequencies for their respective SCCs to avoid interference. Any one or more of these SCCs may be implemented as a new carrier type being developed for Release 11 that is not intended to be backward compatible with UEs that are not CA capable. One area in which such a component carrier may not be backward compatible is the downlink control channel; the new carriers may not utilize the Release-8 physical downlink control channel (PDCCH) and may not use common reference signals (CRSs), instead utilizing what is termed an enhanced PDCCH (ePDCCH) which is the subject of ongoing research under coordination of the 3GPP (see document RP-111776; 3GPP Work Item for ENHANCED DOWNLINK CONTROL CHANNEL(S) FOR LTE).

A problem arises in the direction for this new carrier type now being studied by the 3GPP which is to allow it to be stand-alone rather than as a SCC always associated with a backward compatible PCC. Specifically, it has been agreed that this new carrier type in Release 11 will have only the ePDCCH configured, meaning the PDCCH (which is wide band and occupies 1 to 3 OFDM symbols) will be replaced by the ePDCCH whose resources can be more flexibly configured. If as in earlier discussions this new carrier type was to be a SCC always associated with a PCC, the user equipments (UEs) could be informed of its currently deployed flexible configuration via the PCC. But a mandatory association with a PCC was considered too limiting and so the new carrier type is now to be stand-alone to further enhance spectrum efficiency and improve cell deployment flexibility. See for example two presentations at a CMCC TD-LTE workshop in April 2012; one by Ericsson entitled VIEWS ON TD-LTE FOR REL-12, and another by China Mobile entitled TD-LTE EVOLUTION AND SHARING OF TD-LTE TRIAL.

Enabling a stand-alone new carrier type without CRS and without legacy control channels such as the PDCCH are not themselves the main difficulty, but rather that the configuration of this new ePDCCH is also flexible but there may not be an associated PCC over which to inform the UEs of the current ePDCCH configuration. Consider how legacy Release 10 operates for initial channel access: the UE detects the physical control format indicator channel (PCFICH) first after detecting the primary and/or secondary synchronization signals (PSSSSS) and the broadcast channel (BCH, which gives the master information block MIB of the system information SI). The UE can determine from the PSS/SSS/BCH the size of the PDCCH region and also get the candidates for the downlink control indicator (DCI, which gives the format/size of the PDCCH) that the network might use for any given PDCCH.

When the new carrier is to be stand-alone and to utilize an ePDCCH that is flexibly configured, it is not clear how the UE can learn the network's current configuration of the ePDCCH, which is necessary for the UE even to successfully receive system information and other information for the new carrier type that is necessary for the UE to establish a connection and get its user-specific data. With a stand-alone carrier utilizing a flexibly configured ePDCCH, it is not clear from previous iterations of LTE how the UE can specifically learn the control region for scheduling of SIBs, paging, or other UE-dedicated configuration signaling. More generally, how can the UE get initial access to a stand-alone carrier that uses a flexibly configured downlink control channel, even assuming a similar function for the PSS/SSS/BCH?

### SUMMARY

In a first exemplary embodiment of the invention there is a method for controlling a user equipment, comprising: determining by a user equipment at least one first set of physical resource blocks; within search spaces of the determined at least one first set, detecting downlink signaling through which is obtained a configuration for a downlink control channel, wherein the configuration indicates at least one second set of physical resource blocks and at least one search space specific for the user equipment which lies within the at least one second set; and utilizing the obtained configuration to monitor at least some of the search spaces of the determined at least one first set and the at least one search space specific for the user equipment of the at least one second set for further downlink control signaling.

In a second exemplary embodiment of the invention there is an apparatus for controlling a user equipment. In this embodiment the apparatus comprises at least one processor and at least one memory storing a set of computer instructions, which together are arranged to cause the user equipment at least to: determine at least one first set of physical resource blocks; within search spaces of the determined at least one first set, detect downlink signaling through which is obtained a configuration for a downlink control channel, wherein the configuration indicates at least one second set of physical resource blocks and at least one search space specific for the user equipment which lies within the at least one second set; and utilize the obtained configuration to monitor at least some of the search spaces of the determined at least one first set and the at least one search space specific for the user equipment of the at least one second set for further downlink control signaling.

In a third exemplary embodiment of the invention there is a computer readable memory tangibly storing a set of instructions which, when executed on a user equipment causes the user equipment to at least: determine at least one first set of physical resource blocks; within search spaces of the determined at least one first set, detect downlink signaling through which is obtained a configuration for a downlink control channel, wherein the configuration indicates at least one second set of physical resource blocks and at least one search space specific for the user equipment which lies within the at least one second set; and utilize the obtained configuration to monitor at least some of the search spaces of the determined at least one first set and the at least one search space specific for the user equipment of the at least one second set for further downlink control signaling.

### BRIEF DESCRIPTION OF THE DRAWINGS

FIG. 1 is a schematic diagram of an exemplary radio environment comprising a heterogeneous network with a pico cell having a coverage area within a larger coverage area of a macro cell.

FIG. 2 is a flow diagram illustrating procedures for the UE obtaining the configuration for a control channel in a flexibly configured stand-alone carrier according to a first example of these teachings.

FIG. 3 is a flow diagram illustrating procedures for the UE obtaining the configuration for a control channel in a flexibly configured stand-alone carrier according to a second example of these teachings

FIG. 4 is a logic flow diagram that illustrates, from the perspective of the user equipment, the operation of a method, and a result of execution of computer program instructions embodied on a computer readable memory, in accordance with the exemplary embodiments of this invention.

FIG. 5 is a non-limiting example of a simplified block diagram of the relevant network nodes shown at FIG. 1 and also one UE, which are exemplary electronic devices suitable for use in practicing the exemplary embodiments of this invention.

### DETAILED DESCRIPTION

While the examples below are in the context of the LTE (or LTE-Advanced) system and the stand-alone new carrier type for that system, these are non-limiting examples only. The specific examples used in these teachings are readily extendable for other radio access technologies (RATs) which may deploy a stand-alone carrier by any other name that has a control channel that is flexible in how it is deployed, and even to systems which support user devices that are not backwards compatible and unable to access the legacy downlink control channels.

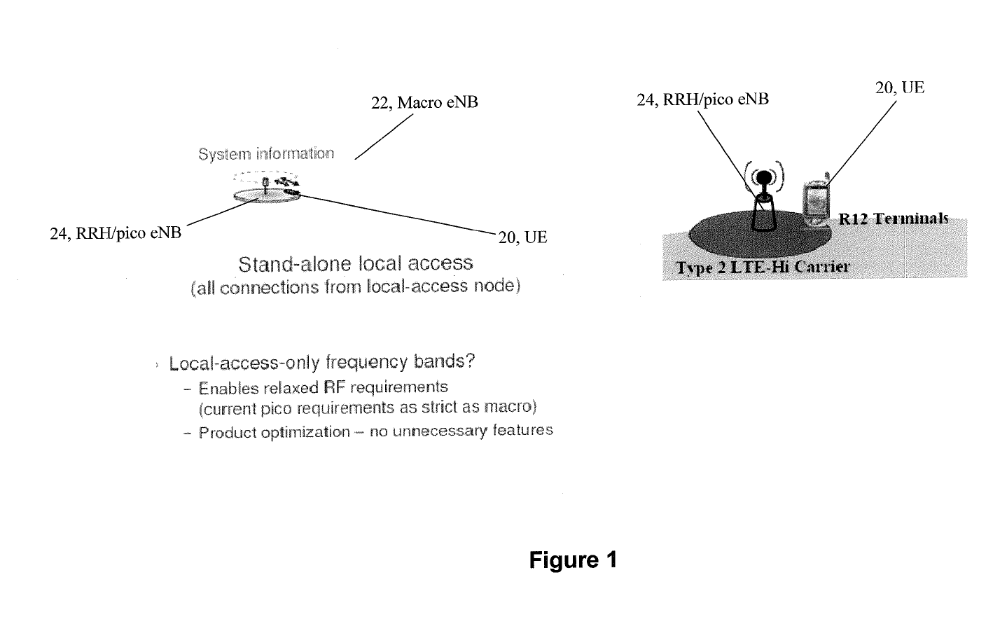

FIG. 1 is a schematic diagram illustrating an exemplary radio environment in which these teachings may be practiced to advantage. There is a heterogeneous network comprising a macro cell controlled by a macro eNB 22, and within that macro coverage area there is one or more pico cells controlled by a pico eNB 24 (which may be implemented as a RRH of the macro eNB 22). These cells operate on different frequencies to avoid interference, or if on the same frequency they utilize some interference mitigation technique such as intercell interference coordination (ICIC) as is known in the art. Generally the macro cell operates as a relatively higher transmit power than the pico cells, which gives rise to the larger and smaller coverage areas.

If the pico eNB 24 is operating a stand-alone carrier for its cell, a UE 20 in the coverage area of the pico cell 24 as FIG. 1 illustrates may need to get all of the needed information for the UE's initial access of the pico eNB 24 from the pico eNB 24 itself, since there is no PCC run by the macro cell 22 that is associated with that stand-alone new carrier being run by the pico cell 24. That is, the stand-alone carrier must be designed to enable all the UE's connections to the wireless network to be through the pico eNB 22. This enables a bit of relaxation of the radiofrequency (RF) requirements for the pico eNB 24 as compared to the macro eNB 22, regardless that the pico eNB 24 may be a RRH of the macro eNB 22 itself.

Before addressing how these teachings resolve the problem of how the UE can know the specific configuration of the ePDCCH in the stand-alone new carrier type, it is helpful to explore a few more details of how the ePDCCH was considered in earlier discussions when it was not to be stand-alone but always associated with a PDCCH or at least a backwards-compatible PCC. Some of the advantages the ePDCCH was to offer was an increased control channel capacity, frequency-domain inter-cell interference coordination (ICIC), improved spatial reuse of control channel resources, and also beam-forming and/or diversity. These are still viable goals for the stand-alone version of the new carrier type.

The flexible configuration of the ePDCCH means its configuration can be UE-specific, to account for the different channel conditions seen by the different UEs. To signal such UE-specific configurations means that different UEs will get the ePDCCH configuration at different times and with different delays. It is reasonable that there will be certain UEs that receive the configuration signaling with a large delay, and so it would be advantageous that there be some fallback control region for that UE to use before it gets some further configuration on the ePDCCH control signaling.

Some earlier discussions of the ePDCCH, when it was assumed that the UE could always access the legacy PDCCH, had the UE-specific ePDCCH configuration scheduled in that PDCCH whose region is known by UE during initial access. This is not viable for a stand-alone new carrier type since there is no legacy PDCCH region or for devices that are capable of supporting an operating bandwidth that is narrower than the legacy PDCCH, but for a more complete view of those earlier discussions can be seen in the following documents all of which are from the 3GPP TSG RAN WG1 Meeting #66bis in Jeju, Korea held on 26-30 Mar. 2012: document R1-121252 by Alcatel-Lucent Shanghai Bell and Alcatel-Lucent entitled SEARCH SPACE DESIGN FOR EPDCCH; document R1-120997 by Huawei and HiSilicon entitled DISCUSSION ON EPDCCH COMMON SEARCH SPACE; document R1-121102 by CATT entitled CONSIDERATION ON E-PDCCH SEARCH SPACE DESIGN; document R1-121476 by NTT DOCOMO entitled ON THE NEED OF COMMON SEARCH SPACE FOR E-PDCCH; and document R1-121199 by Fujitsu entitled REQUIREMENTS AND SIGNALING FOR CONFIGURATION OF UESSS AND CSS ON EPDCCH.

These teachings provide solutions for the ePDCCH configuration in a stand-alone new carrier type, which enables the UE to know the control region to monitor during its initial access of the LTE system. Additionally these teachings enable efficient scheduling of a UE-specific transmission before the UE-specific ePDCCH configuration. The ePDCCH configuration itself can include more than only the control region where the ePDCCH can be found; for example it may include an indication of the demodulation reference signal (DMRS) port and possibly further information for the UE.

To learn the ePDCCH configuration in a stand-alone carrier, first the UE determines a set of physical resource blocks (PRBs). For convenience we can term this set S1. There are various ways to implement this PRB set that the UE can determine. In one implementation the PRB set S1 is predefined and the UE determines this set of PRBs implicitly, or in dependence on one or more parameters of the cellular network such as for example the cell ID, the system frame number, and/or any of the various other parameters the UE can obtain from detecting the PSS/SSS/BCH. In another implementation the PRB set S1 is indicated by some predefined channel such as the ePCFICH.

The search space for the UE to search in the set of PRBs is designed as follows, which the UE is aware of even before it has any further information about the specific ePDCCH configuration. The PRB set S1 contains some common ePDCCH candidates C_{Common}, and also at least one predefined temporary ePDCCH candidate C_{Temporary}. Initially, the UE will detect both common search space candidates C_{Common} and temporary search space candidates C_{Temporary} in PRB set S1, until it detects the UE-specific ePDCCH configuration signaling which can be a higher layer signaling conveyed by a physical downlink shared channel PDSCH. This PDSCH transmission is scheduled by one ePDCCH candidate in C_{Common} or C_{Temporary}. Once the UE-specific ePDCCH configuration signaling is detected, the UE now knows the ePDCCH configuration and can detect both the common search space candidates C_{Common} that are in PRB set S1 and also any (one or more) UE-specific search space candidates C_{Specific} that are in PRB set S2. The PRB set S2 is configured by the UE-specific ePDCCH configuration signaling mentioned above, and once the UE knows the ePDCCH configuration and the UE-specific search space candidates C_{Specific} it no longer needs to detect any temporary search space candidates C_{Temporary} that are in PRB set S1.

In order to assist the network to efficiently schedule the UE in the ePDCCH which lies somewhere in PRB set S1, especially when the network wants to schedule the UE in C_{Temporary}, the UE will report a channel quality indication during the initial network access, such as in Message 3. In the initial access the UE typically selects a signature sequence and sends it on the random access channel (RACH) at a specific transmit power level; this is message 1. The UE then tunes to the access indicator channel (AICH) at a specific time mapped from when it sent message 1 to receive the network's random access response; this is message 2. If the network granted an uplink resource in message 2, then the UE tunes to that physical uplink shared channel PUSCH and sends its data in message 3. If the network does not grant a PUSCH in message 2 the UE repeats the process again but while imposing a backoff timer and a step up in transmit power. In these teachings the UE will measure CQI on some downlink channel and send that CQI in message 3 during its initial channel access/RACH procedure. The downlink channel could be the PSS/SSS/BCH, or more preferably can be from measuring reference signals in the PRB set S1 or measuring reference signals wideband over the whole carrier bandwidth.

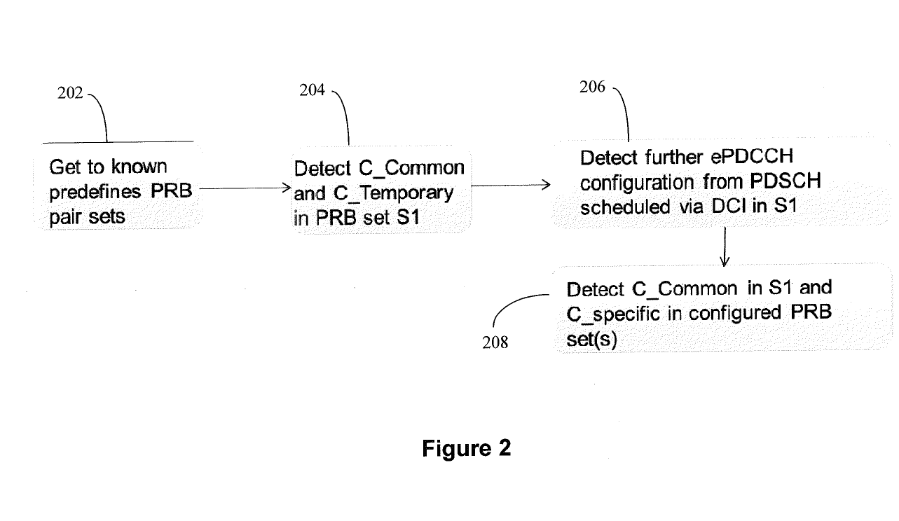

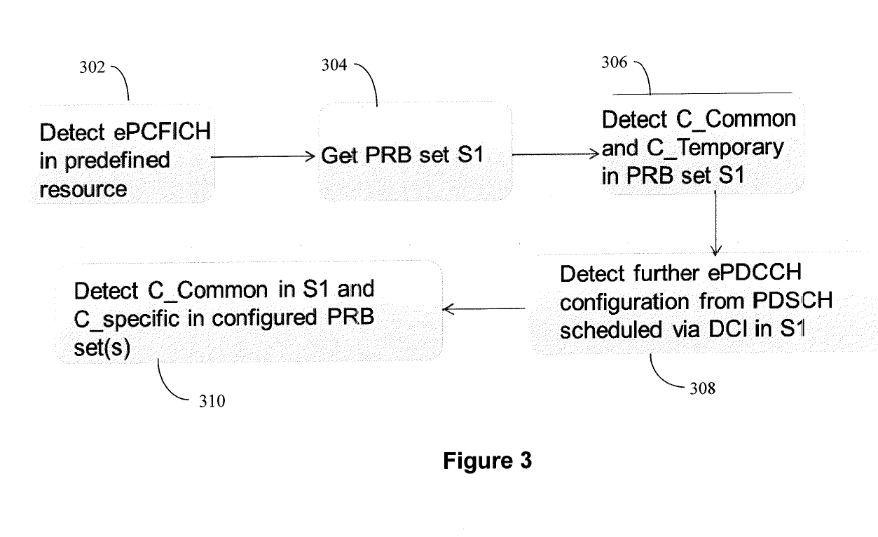

To more fully explain these various implementations that are summarized above, FIGS. 2-3 present two logic flow diagrams outlining two different examples for how the UE can determine the semi-dynamic (UE-specific) ePDCCH configuration for the stand-alone carrier.

FIG. 2 begins at block 202 in which the UE determines the PRB pair set S1. Since there are two slots in each transmission time interval and the same PRB is in those two slots the PRBs are sometimes referred to as PRB pairs, so the set S1 may be referred to as a PRB set or equivalently as a PRB pair set or as PRB pair sets. As noted above, the UE can know this PRB set implicitly based some predefinition published in a radio access technology standard, or the UE can determine the PRB set based on the cell-ID, system frame number, and/or some other information the UE obtains from any one or more of the PSS/SSS/BCH. In one specific but non-limiting example, S1 can be one predefined resource block group (RBG) subset of PRBs, such as for example in resource allocation type 1 for the PDSCH. In another non-limiting example that may be used in conjunction with the first, the UE can use additional information such as the network may include in the master information block (MIB) to determine the size of the PRB set S1.

FIG. 2 continues at block 204 in which the UE detects the common search space candidates C_{Common} in the selected PRB set S1, and the UE additionally detects one or more predefined temporary UE-specific candidates C_{Temporary}. In one non-limiting example for block 204, C_{Temporary} can be six DCI candidates with aggregation level 1 and six DCI candidates with aggregation level 2. In another non-limiting example, the number of candidates in C_{Temporary} or/and in C_{Common} can be determined based on the size of the PRB set S1.

As noted above, introducing one or more temporary UE-specific search space candidates helps the network to schedule the various UEs more efficiently. If the UEs are only allowed to detect C_{Common}, this may result in the network being limited to schedule them only with a large aggregation level, e.g, 4, 8 or even larger one, since the common search space is designed to guarantee large coverage. However, this is neither a necessary limitation nor it is efficient. By having the UEs also detect temporary UE-specific candidates C_{Temporary}, the network would then be able to schedule the UEs with a low aggregation level, e.g, 1 or 2.

The RACH procedure helps the eNB (eNodeB, the base station or other network access node) to determine the aggregation level to be used for a UE-specific ePDCCH. For example, in the network's detection of the RACH preamble (message 1), the eNB can determine the timing advance for this UE and then make a rough estimation of the path loss to this same UE. This information helps the network to select a more efficient aggregation level for the UE. And further by having the UE report CQI during the RACH procedure as mentioned above it can provide the network with improved accuracy for the channel status. The CQI can be wideband based on reference signal estimation in the whole band, or the UE can measure the reference signal only in the PRB set S1 for its CQI report. As an alternative the UE's reported CQI can even be based on its measurement of the PSS/SSS/BCH. Reporting this CQI in message 3 of the RACH procedure enables efficient ePDCCH transmission by the network at the earliest possible time.

Returning to FIG. 2, if at block 206 the UE detects that there is a UE-specific ePDCCH configuration signaling by which the network has configured a new ePDCCH region for UE-specific search space in the stand-alone carrier, then the UE will not attempt to detect the C_{Temporary} in S1 any longer at block 208, but will instead attempt to detect C_{Common} in the PRB set S1 and also the UE-specific search space candidates C_{UE-Specific} in the newly configured PRB set (S2), which may not be identical to the original set S1 (but it may overlap).

If further development of the stand-alone new carrier type progresses such that it is to introduce a configurable ePHICH, the ePHICH can be located in same PRB set S1 and the various UEs initially will monitor this ePHICH region for the acknowledgement/negative acknowledgement (ACK/NACK) for the PUSCH. When later new UE-specific ePDCCH is configured, the UEs can detect the ePHICH in the new ePDCCH PRB set S2 or in the original PRB set S1 (if the ePHICH itself hasn't been moved/reconfigured), depending on how much the configuration of the ePHICH has changed. In either case the UE knows where to search for the newly configured ePHICH.

For the example illustrated by FIG. 3 the UE learns the PRB set S1 from the ePCFICH. There the UE first detects the ePCFICH at block 302, and the UE knows where to find the ePCFICH since it lies in a predefined radio resource (for example, its location within the stand-alone carrier is published in a radio access technology standard, such as at the center frequency of the carrier bandwidth, or offset some specific amount from the center, etc.). The ePCFICH is only one example, the predefined radio resource/frequency can be for some other control channel. Block 304 has the UE determining the PRB set S1 from the ePCFICH or other control channel at the predefined resource. So as one non-limiting example, the ePCFICH can indicate dynamically the ePDCCH region (including for example a distributed ePDCCH region and a localized ePDCCH region), and the UE can implicitly derive the PRB set S1 as the distributed ePDCCH region (or part of it, for example the first k PRB set(s) indicated by ePCFICH make up the distributed region, where k is some non-zero integer).

Then block 306 of FIG. 3 can be similar to block 204 in FIG. 2; the UE detects in the PRB set S1 the common search space C_{Common}, and also detects the C_{temporary}, where C_{temporary} is in fact the UE-specific distributed ePDCCH search space. Note that presence of the common search space C_{Common} implies that the PRB set S1 derived by different UEs can overlap only partly; the C_{common} part will be the same while the C_{temporary} part can be different since it is the UE-specific ePDCCH search space in PRB set S1.

Further at FIG. 3, the network decides to change the ePDCCH configuration and so the UE at block 308 detects the new ePDCCH configuration. In this case the UE already has the old ePDCCH configuration and so the network can trigger the UE to monitor the new dedicated ePDCCH configuration (PRB pair set S2) via signaling scheduled by one ePDCCH candidate in the common search spaces C_{common} or C_{temporary}. The new dedicated ePDCCH region (PRB set S2) can be another part indicated by ePCFICH. That is, the network re-configured the ePDCCH to change the UE-specific search spaces, for example due to changing channel conditions. In this case the common search spaces C_{Common} are unchanged and remain in PRB set S1, and the network's ePDCCH reconfiguration signaling triggers the UE to monitor the new UE-specific ePDCCH region (maybe localized ePDCCH region) C_{specific} in PRB set S2, which is part of the resource indicated by ePCFICH, e.g, the last n PRB pairs for localized ePDCCH detection.

While the above examples have it indicating only one, the ePCFICH (or other control channel) can indicate multiple PRB sets. Each UE initially will monitor only the PRB set S1, and later can be triggered by dedicated signaling on the ePCFICH that indicates another PRB set or multiple other PRB sets for the UE to monitor and search.

Exemplary embodiments of these teachings exhibit the technical effect of enabling the UEs, during initial network access, to unambiguously know the control region to access despite that the control region is configurable by the network in a stand-alone carrier. An additional technical effect is that these teachings enable robust and efficient UE scheduling before the UE receives further UP-specific signaling about the ePDCCH configuration.

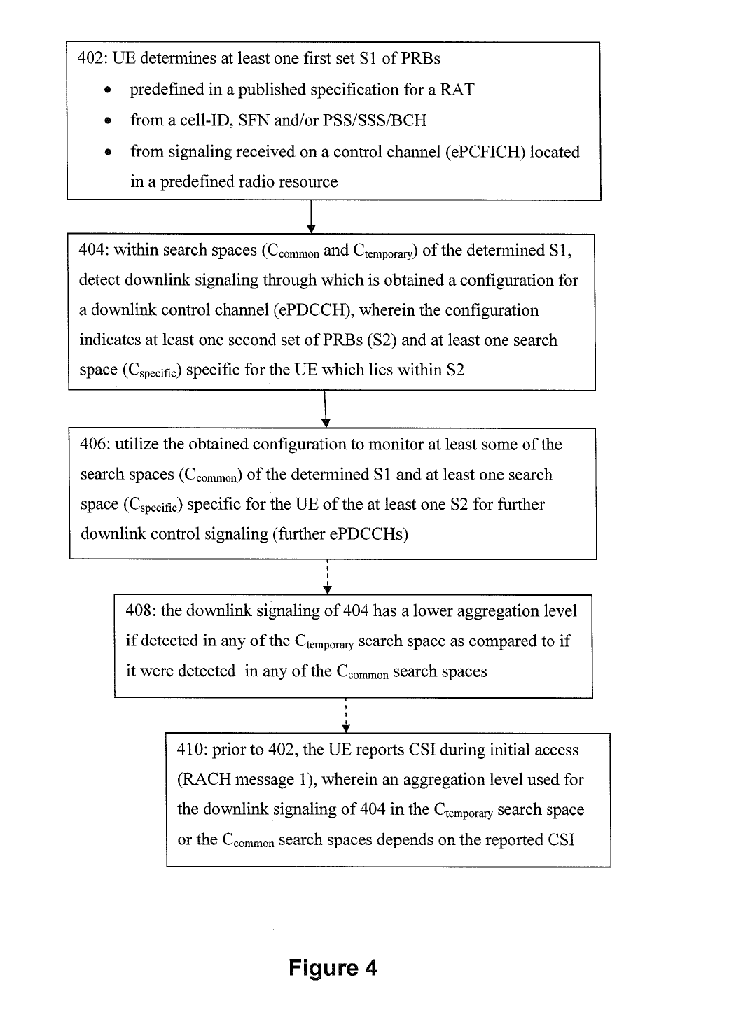

FIG. 4 is a logic flow diagram that summarizes some example embodiments of the invention. FIG. 4 describes from the perspective of the user equipment UE 20, and may be considered to illustrate the operation of a method, and a result of execution of a computer program stored in a computer readable memory, and a specific manner in which components of an electronic device are configured to cause that UE 20 to operate. In this regard the process flow of FIG. 4 may describe operation of the whole UE, or of certain components thereof such as a modem, chipset, a USB dongle, or the like.

Such blocks and the functions they represent are non-limiting examples, and may be practiced in various components such as integrated circuit chips and modules, and that the exemplary embodiments of this invention may be realized in an apparatus that is embodied as an integrated circuit. The integrated circuit, or circuits, may comprise circuitry (as well as possibly firmware) for embodying at least one or more of a data processor or data processors, a digital signal processor or processors, baseband circuitry and radio frequency circuitry that are configurable so as to operate in accordance with the exemplary embodiments of this invention.

Such circuit/circuitry embodiments include any of the following: (a) hardware-only circuit implementations (such as implementations in only analog and/or digital circuitry) and (b) combinations of circuits and software (and/or firmware), such as: (i) a combination of processor(s) or (ii) portions of processor(s)/software (including digital signal processor(s)), software, and memory(ies) that work together to cause an apparatus, such as a UE or portable wireless radio device, to perform the various functions summarized at FIG. 4 and (c) circuits, such as a microprocessor(s) or a portion of a microprocessor(s), that require software or firmware for operation, even if the software or firmware is not physically present. This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” also covers, for example, a baseband integrated circuit or applications processor integrated circuit for a UE or a similar integrated circuit in another portable radio device.

At block 402 of FIG. 4 the UE determines at least one first set of physical resource blocks. In the above examples this was S1, but there may be more than one set of PRBs in this initial determination by the UE. Above were detailed various ways the UE can learn the set (or sets) S1 which are briefly summarized also at block 402 as non-limiting embodiments. Specifically, the set or sets S1 may be predefined in a published specification for a radio access technology RAT, or the UE may determine S1 from at least one of a cell identifier (cell-ID), a system frame number (SFN), a synchronization signal (PSS and/or SSS) and a broadcast channel (BCH). In other embodiments the UE can determine S1 from signaling received on a control channel (such as the ePCFICH) located in a predefined radio resource, such as where the ePCFICH indicates a resource for an enhanced PDCCH channel over which the UE can get the configuration shown at block 404.

In block 404 the UE gets the ePDCCH configuration, which is different from simply receiving one instance of an ePDCCH in a common or temporary search space. Block 404 details that within search spaces of the determined at least one first set (these are the C_{common} and at least one C_{temporary} search spaces), the UE detects downlink signaling (such as an individual instance of an ePDCCH) through which is obtained a configuration for a downlink control channel. In one of the above examples the UE receives the one instance of the ePDCCH in C_{Common} and at least one C_{temporary}, which schedules the UE for a PDSCH, and the UE gets the rest of the ePDCCH configuration on that scheduled PDSCH. Returning to block 404, the ePDCCH configuration indicates at least one second set of physical resource blocks, and at least one search space specific for the user equipment which lies within the at least one second set. In the above examples these were the PRB set S2 and the C_{specific} search space(s), respectively.

Then at block 406 of FIG. 4 the UE utilizes the obtained configuration to monitor at least some of the search spaces of the determined at least one first set and the at least one search space specific for the user equipment of the at least one second set. The UE monitors these for further downlink control signaling, such as additional ePDCCHs that are used in the normal course of communicating traffic on the PDSCH and PUSCH to and from the UE. Specifically, what the UE monitors is the C_{common} search spaces in S1 and the C_{specific} search spaces in S2; once the UE has the whole ePDCCH configuration it knows the C_{specific} search spaces and can exclude monitoring of the one or more C_{temporary} search spaces that lie in S1.

But note that the C_{specific} search spaces and the C_{temporary} search spaces may overlap because the PRB sets S1 and S2 may overlap. For example, if the UE provides CQI in its initial RACH access the network can set the C_{temporary} search spaces based on that CQI, and the network may decide these search spaces are quite suitable for the UE and so the C_{temporary} search space(s) effectively become the C_{SPECIFIC} search space(s) in a PRB that is in both S1 and S2. From the UE's perspective in this example, once the UE gets the ePDCCH configuration the UE's programming may tell it that it no longer needs to monitor the C_{temporary} search space(s) in S1 and now needs to monitor the C_{specific} search space(s) in S2 (as well as the C_{common} search spaces in S1 which is unchanged), despite that C_{temporary} and C_{specific} may be the exact same search spaces.

The dashed lines in FIG. 4 represent additional and optional steps. Block 408 summarizes the aggregation level aspects of the invention which are detailed more fully above. Recall that the UE can get its initial instance of the ePDCCH (which allows it to get the configuration of the whole ePDCCH region) in either the C_{common} or the C_{temporary} search spaces. Block 408 tells that this downlink signaling (the initial ePDCCH instance) has a lower aggregation level if the UE detected it in any of the C_{temporary} search spaces than it would if the UE detected it in any of the C_{common} search spaces.

Block 410 summarizes how early reporting of CQI can aid the network in its sending of that initial ePDCCH instance to the UE. Specifically, and this occurs prior to block 402 in FIG. 4 but is listed in block 410 because it is only optional yet still relates to block 408, the UE reports CQI during initial access (for example, in message 1 of the RACH procedure), and whatever aggregation level is used for the downlink signaling (the instance of the initial ePDCCH) that the UE detects in the C_{common} or in the C_{temporary} search spaces depends on the reported CQI.

For the stand-alone carrier aspects of these teachings, all of the following will be within the bandwidth of that one stand-alone carrier:
the (one or more) first set of PRBs S1 at block 402 of FIG. 4;
the (one or more) second set of PRBs S2 at block 404 of FIG. 4;
the detected downlink signaling (ePDCCH instance) at block 404 of FIG. 4; and
the downlink control channel (the ePDCCH region) for which the configuration is received at block 404 of FIG. 4.

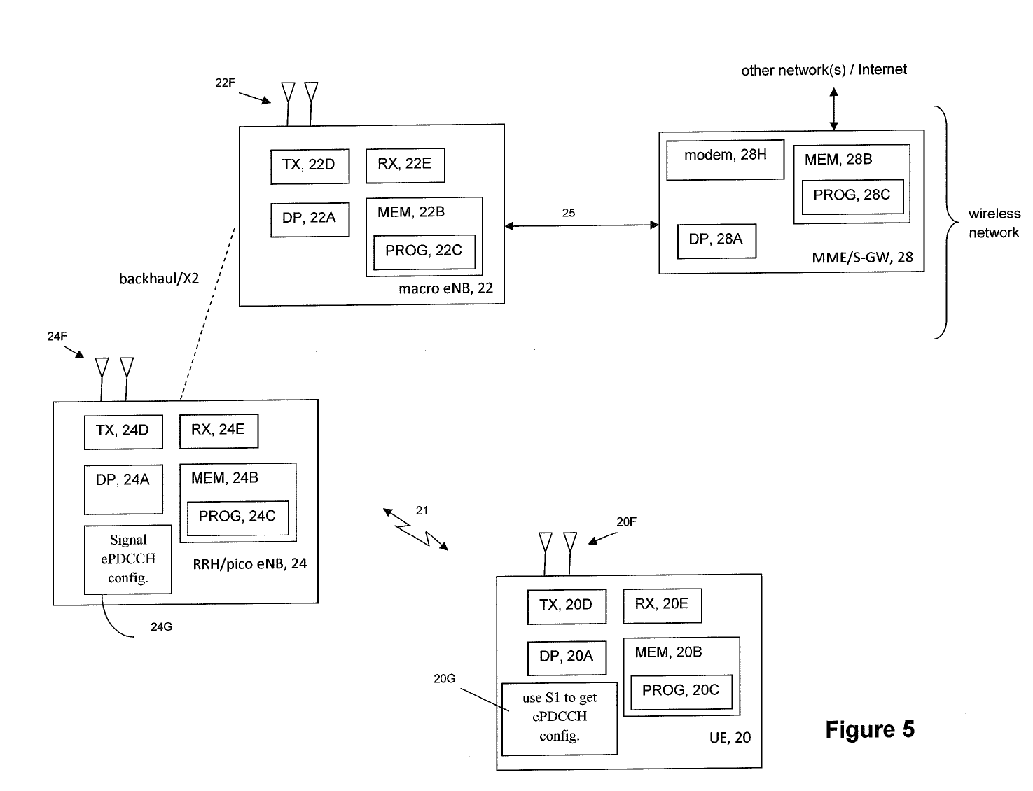

Reference is now made to FIG. 5 for illustrating a simplified block diagram of various electronic devices and apparatus that are suitable for use in practicing the exemplary embodiments of this invention. In FIG. 5 a wireless network (RRH/pico eNB 14 and macro eNB 22 and mobility management entity MME and/or serving gateway S-GW 28) is adapted for communication with a portable radio apparatus, such as a mobile terminal or UE 20. In the example scenario this communication is over only a stand-alone new carrier type with the flexibly configured ePDCCH, and so only one bidirectional radio link 21 is shown between the UE 20 and the RRHpico eNB 24. In other deployments it may be the macro eNB 22 that is running the new carrier type as a stand-alone carrier with this particular UE 20. In other viable network types the macro/pico eNBs is a base station or access point or other specific type of a more generic network access node. In the case of a LTE or LTE-A network it may include the MMES-GW 28 which provides connectivity with further networks (e.g., a publicly switched telephone network PSTN and/or a data communications network/Internet). Other types of networks have a similar function for accessing other data networks and the Internet. Only one UE 20 is shown but in many deployments there will be one or more under each of the macro eNB 22 and possibly also the RRHpico eNB 24.

The UE 20 includes processing means such as at least one data processor (DP) 20A, storing means such as at least one computer-readable memory (MEM) 20B storing at least one computer program (PROG) 20C, communicating means such as a transmitter TX 20D and a receiver RX 20E for bidirectional wireless communications with the network access node 24 via one or more antennas 20F. Also stored in the MEM 20B at reference number 20G are the UE's rules for how to find S1, and how to use S1 to obtain the configuration for the control channel region (the ePDCCH region) as is detailed above with specificity.

The macro eNB 22 and also includes processing means such as at least one data processor (DP) 22A, storing means such as at least one computer-readable memory (MEM) 22B storing at least one computer program (PROG) 22C, and communicating means such as a transmitter TX 22D and a receiver RX 22E for bidirectional wireless communications with any UEs under its direct control via one or more antennas 22F. There is also a data and/or control path 25 coupling the macro eNB 22 with the MMES-GW 28, and another data and/or control path shown as backhaul/X2 coupling the macro eNB 22 with the RRHpico eNB 24.

The RRHpico eNB 24 is also illustrated as having a data processor (DP) 24A; storing means/computer-readable memory (MEM) 24B storing at least one computer program (PROG) 24C; and communicating means such as a transmitter TX 24D and a receiver RX 24E for bidirectional wireless communications with the attached UE 20 via one or more antennas 24F. The RRHpico eNB 24 also includes at unit 24G its logic for semi-statically configuring the ePDCCH region, and for signaling the ePDCCH configuration to the UE 20 as is detailed with specificity above.

For completeness we note that the MMES-GW 28 includes processing means such as at least one data processor (DP) 28A, storing means such as at least one computer-readable memory (MEM) 28B storing at least one computer program (PROG) 28C, and communicating means such as a modem 28H for bidirectional communications with the macro eNB 22 via the datacontrol path 25. While not particularly illustrated for the UE 20 or eNBs 22, 24, those devices are also assumed to include as part of their wireless communicating means a modem which may be inbuilt on an RF front end chip within those devices 20, 22, 24 and which RF front end chip may also carry the TX 20D/22D/24D and the RX 20E/22E/24E.

At least one of the PROGs 24C/24G in the RRHpico eNB 24 (or within the macro eNB 22 if the macro eNB 24 is operating the new stand alone carrier) is assumed to include program instructions that, when executed by the associated DP 24A, enable the device to operate in accordance with the exemplary embodiments of this invention, as detailed above. The UE 20 also has software stored in its MEM 20C/20G to implement the UE-related aspects of these teachings as detailed above. In this regard the exemplary embodiments of this invention may be implemented at least in part by computer software stored on the MEM 20B/22B/24B which is executable by the DP 20A of the UE 20 and/or by the DP 22A/24A of the relevant access node/eNB 22, 24; or by hardware, or by a combination of tangibly stored software and hardware (and tangibly stored firmware). Electronic devices implementing these aspects of the invention need not be the entire UE 20 or eNB 22, 24, but exemplary embodiments may be implemented by one or more components of same such as the above described tangibly stored software, hardware, firmware and DP, modem, USB dongle, system on a chip SOC or an application specific integrated circuit ASIC.

In general, the various embodiments of the UE 20 can include, but are not limited to personal portable digital devices having wireless communication capabilities, of which non-limiting examples include cellular telephones/mobile terminals, navigation devices, laptop/palmtop/tablet computers, digital cameras and Internet appliances.

Various embodiments of the computer readable MEMs 20B, 22B, 24B and 28B include any data storage technology type which is suitable to the local technical environment, including but not limited to semiconductor based memory devices, magnetic memory devices and systems, optical memory devices and systems, fixed memory, removable memory, disc memory, flash memory, DRAM, SRAM, EEPROM and the like. Various embodiments of the DPs 20A, 22A, 24A and 28A include but are not limited to general purpose computers, special purpose computers, microprocessors, digital signal processors (DSPs) and multi-core processors.

Some of the various features of the above non-limiting embodiments may be used to advantage without the corresponding use of other described features. The foregoing description should therefore be considered as merely illustrative of the principles, teachings and exemplary embodiments of this invention, and not in limitation thereof.

1. A method comprising:
determining by a user equipment at least one first set of physical resource blocks;
within search spaces of the determined at least one first set, detecting downlink signaling through which is obtained a configuration for a downlink control channel, wherein the configuration indicates at least one second set of physical resource blocks and at least one search space specific for the user equipment which lies within the at least one second set; and
utilizing the obtained configuration to monitor at least some of the search spaces of the determined at least one first set and the at least one search space specific for the user equipment of the at least one second set for further downlink control signaling.

2. The method according to claim 1, wherein:
the at least one first set of physical resource blocks is predefined in a published specification for a radio access technology.

3. The method according to claim 1, wherein:
the at least one first set of physical resource blocks is determined from at least one of a cell identifier, a system frame number, a synchronization signal and a broadcast channel.

4. The method according to claim 1, wherein:
the at least one first set of physical resource blocks is determined from signaling received on a control channel located in a predefined radio resource.

5. The method according to claim 4, wherein
the control channel located in the predefined resource is an enhanced PCFICH channel indicating a resource for an enhanced PDCCH channel.

6. The method according to claim 1, wherein:
the search spaces of the determined at least one first set comprise common search spaces and at least one temporary search space that is specific for the user equipment;
the said at least some of the search spaces of the determined at least one first set which are monitored comprise the common search spaces and exclude the temporary search spaces; and
each of the first and second sets of physical resource blocks, and the detected downlink signaling, and the downlink control channel, are within a bandwidth of one carrier.

7. The method according to claim 6, wherein the downlink signaling has a lower aggregation level if detected in any of the at least one temporary search space as compared to being detected in any of the common search spaces.

8. The method according to claim 7, the method further comprising initial steps of the user equipment reporting channel state information during initial access, wherein an aggregation level used for the downlink signaling in the at least one temporary search space or the common search spaces depends on the reported channel state information.

9. The method according to claim 1, wherein the configuration for the downlink control channel is configuration for an enhanced physical downlink control channel ePDCCH, and the configuration is received on a downlink physical shared channel PDSCH which is scheduled for the user equipment in the detected downlink signaling which is an ePDCCH.

10. An apparatus for controlling a user equipment, comprising at least one processor; and
a memory storing a set of computer instructions,
wherein the at least one processor is arranged with the memory storing the instructions to cause the user equipment at least to:
determine at least one first set of physical resource blocks;
within starch spaces of the determined at least one first set, detect downlink signaling through which is obtained a configuration for a downlink control channel, wherein the configuration indicates at least one second set of physical resource blocks and at least one search space specific for the user equipment which lies within the at least one second set; and
utilize the obtained configuration to monitor at least some of the search spaces of the determined at least one first set and the at least one search space specific for the user equipment of the at least one second set for further downlink control signaling.

11. The apparatus according to claim 10, wherein:
the at least one first set of physical resource blocks is predefined in a published specification for a radio access technology.

12. The apparatus according to claim 10, wherein:
the at least one first set of physical resource blocks is determined from at least one of a cell identifier, a system frame number, a synchronization signal and a broadcast channel.

13. The apparatus according to claim 10, wherein:
the at least one first set of physical resource blocks is determined from signaling received on a control channel located in a predefined radio resource.

14. The apparatus according to claim 13, wherein
the control channel located in the predefined resource is an enhanced PCFICH channel indicating a resource for an enhanced PDCCH channel.

15. The apparatus according to claim 10, wherein:
the search spaces of the determined at least one first set comprise common search spaces and at least one temporary search space that is specific for the user equipment;
the said at least some of the search spaces of the determined at least one first set which are monitored comprise the common search spaces and exclude the temporary search spaces; and
each of the first and second sets of physical resource blocks, and the detected downlink signaling, and the downlink control channel, are within a bandwidth of one carrier.

16. The apparatus according to claim 15, wherein the downlink signaling has a lower aggregation level if detected in any of the at least one temporary search space as compared to being detected in any of the common search spaces,

17. The apparatus according to claim 16, wherein the at least one processor is arranged with the memory storing the instructions to cause the user equipment, prior to the determining, to report channel state information during initial access, wherein an aggregation level used for the downlink signaling in the at least one temporary search space or the common search spaces depends on the reported channel state information.

18. The apparatus according to claim 10, wherein the configuration for the downlink control channel is configuration for an enhanced physical downlink control channel ePDCCH, and the configuration is received on a downlink physical shared channel PDSCH which is scheduled for the user equipment in the detected downlink signaling which is an ePDCCH.

19. A computer readable memory tangibly storing a set of instructions which, when executed on a user equipment, causes the user equipment to at least:
determine at least one first set of physical resource blocks;
within search spaces of the determined at least one first set, detect downlink signaling through which is obtained a configuration for a downlink control channel, wherein the configuration indicates at least one second set of physical resource blocks and at least one search space specific for the user equipment which lies within the at least one second set; and
utilize the obtained configuration to monitor at least some of the search spaces of the determined at least one first set and the at least one search space specific for the user equipment of the at least one second set for further downlink control signaling.

20. The computer readable memory according to claim 19, wherein:
the at least one first set of physical resource blocks is predefined in a published specification for a radio access technology.

21.-27. (canceled)
